(19) United States
(12) Patent Application Publication
(10) Pub. No.: US 2019/0073680 A1
(43) Pub. Date: Mar. 7, 2019

(54) INTERFACES AND METHODS FOR LICENSING MEDIA

(71) Applicant: AKM Productions Inc., Valencia, PA (US)

(72) Inventor: Andrew KNOX, Valencia, PA (US)

(21) Appl. No.: 16/179,535

(22) Filed: Nov. 2, 2018

Related U.S. Application Data
(63) Continuation-in-part of application No. 15/143,809, filed on May 2, 2016.

(51) Int. Cl. G06Q 30/00; G06F 21/10

(52) U.S. Cl. CPC G06Q 30/018; G06F 2221/0766; G06F 21/105

(57) ABSTRACT

In various embodiments, tools and techniques are provided for automatically retrieving data associated with licensing media. One method includes receiving, in a computer system, a request including inputs identifying parameters for matching different media licenses or media license types. The computer system employs a load balancer for determining a server to process the request. Based on the received parameters, matching media licenses are identified and displayed for access by a user interface. Also, based on the request, the method involves locating and retrieving content stored in different data storage media in response to a quality attribute associated with the content.

### CROSS-REFERENCE APPLICATION

This application is a continuation-in-part application claiming the benefit of priority of co-pending U.S. patent application Ser. No. 15/143,809, filed May 2, 2016, which is incorporated in its entirety herein by reference.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to access data stored in local or remote data stores. These data stores are often referred to as databases. Computer databases allow applications to request data using queries. When the database receives the query, it looks up data corresponding to the query and returns the data to the application. Substantially any type of data may be stored in a database, including, for example, media items and data associated therewith. The media items may include songs, movies, photos or other types of media. The information associated with the media items may include, for example, title, album, artist, photographer, or other information. Indeed, in some cases, the data may include licensing information associated with the media items.

### BRIEF SUMMARY

Embodiments described herein are directed to purchasing and storing media licenses and to identifying and presenting media licenses base on parameters. In one embodiment, a computer system instantiates a user interface that includes the following: a field configured to present information relating to identified media licenses, an actionable element that allows selection of the type of media license to be acquired by a user for a selected media item, a field that displays a determined price for the selected type of media license, and an actionable element that processes payment for the selected type of media license. The purchased license is added to a collection of media licenses that includes the purchased media license and any previously purchased media licenses.

In another embodiment, a computer system identifies and presenting media licenses base on parameters. The computer system receives inputs identifying a parameter that is to be matched to different media licenses or media license types. Based on the parameter, the computer system identifies media licenses that correspond to the parameter, displays the identified media licenses for selection by a user and, upon selection by the user, adds the media license to a collection of media licenses that are to be purchased.

In yet another embodiment, a computer system is provided that includes the following: a processor, a display for displaying information relating to identified media licenses, an input receiver for receiving input indicating that a specified type of media license is to be acquired by a user, a price calculating module that determines a price for the selected type of media license, where the display displays the determined price for the selected type of media license, and a payment processor that causes payment to be processed for the selected type of media license, where the purchased media license is added to a collection of media licenses including the purchased license and any previously purchased media licenses.

In another embodiment, a computer-based method is provided for automatically retrieving data associated with licensing media. The method may include receiving a request including inputs identifying at least one parameter for matching to one or more different media licenses or media license types. A load balancer can be used for determining at least one backend server of the computer system for processing the received request. One or more media licenses can be identified that correspond to the identified parameters. Also, based on the request, the method involves locating content within data storage media operatively associated with the processor. The located content can be communicated from the data storage media portion in response to a quality attribute associated with the content and with the request. The method may further include providing access to the located content, and also displaying identified media licenses, for selection by the user. A selected media license can be added to a collection of media licenses that are to be purchased.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including identifying and presenting media licenses based on parameters.

FIGS. 2A-2P illustrate embodiments in which a media license is displayed, selected and purchased.

FIGS. 3A-3E illustrate an embodiment in which a media license is shared with an authorized user.

FIGS. 4A-4C illustrate an embodiment in which a media license is shared with an unauthorized user.

FIGS. 5 illustrates a flowchart of an example method for identifying and presenting media licenses base on parameters.

FIG. 6 includes a screen display showing examples of content which can be licensed through the computer systems described herein.

FIG. 7 includes a screen display illustrating examples of licensing rates or prices for different content.

FIGS. 8A-8C include screen displays demonstrating use and application of one example of a budget filter tool.

FIG. 9 includes a screen display showing an example of search results obtained as a result of parameters applied in a search for licensing content.

FIGS. 10A and 10B include screen displays illustrating an example of a license clearance tool.

FIG. 11 includes a screen display illustrating an example of a summary list of content licensed by a user through the computer system described herein.

FIG. 12 includes a schematic depiction of an example of a computer architecture structured for processing requests for content and for retrieving content from data storage based on predetermined parameters.

### DETAILED DESCRIPTION

Embodiments described herein are directed to purchasing and storing media licenses and to identifying and presenting media licenses base on parameters. In one embodiment, a computer system instantiates a user interface that includes the following: a field configured to present information relating to identified media licenses, an actionable element that allows selection of the type of media license to be acquired by a user for a selected media item, a field that displays a determined price for the selected type of media license, and an actionable element that processes payment for the selected type of media license. The purchased license is added to a collection of media licenses that includes the purchased media license and any previously purchased media licenses.

In another embodiment, a computer system identifies and presenting media licenses base on parameters. The computer system receives inputs identifying a parameter that is to be matched to different media licenses or media license types. Based on the parameter, the computer system identifies media licenses that correspond to the parameter, displays the identified media licenses for selection by a user and, upon selection by the user, adds the media license to a collection of media licenses that are to be purchased.

In yet another embodiment, a computer system is provided that includes the following: a processor, a display for displaying information relating to identified media licenses, an input receiver for receiving input indicating that a specified type of media license is to be acquired by a user, a price calculating module that determines a price for the selected type of media license, where the display displays the determined price for the selected type of media license, and a payment processor that causes payment to be processed for the selected type of media license, where the purchased media license is added to a collection of media licenses including the purchased license and any previously purchased media licenses.

The media license purchasing and identifying embodiments described herein may be implemented on various types of computing systems. These computing systems may take a wide variety of forms. Such computing systems may, for example, be mobile phones, electronic appliances, laptop computers, tablet computers, wearable devices, desktop computers, mainframes, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, nonvolatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed fitnctionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

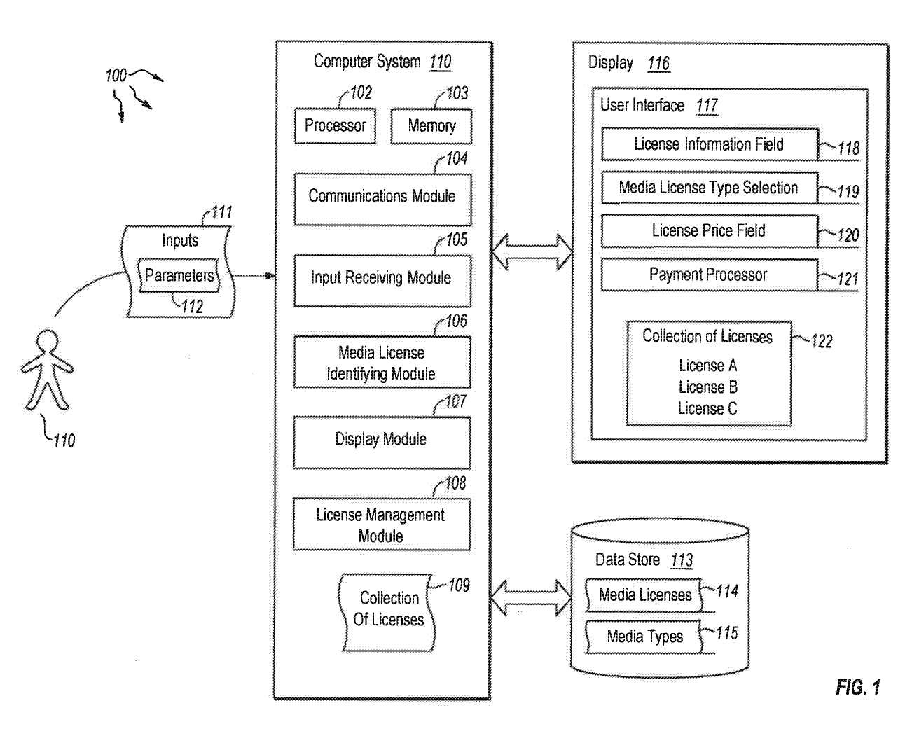

Referring to the figures, FIG. 1 illustrates a computer architecture 100 in which at least one embodiment described herein may be employed. The computer architecture 100 includes a computing system 101. The computing system 101 may be any type of local or distributed computing system, including a cloud computing system. The computing system 101 includes at least one hardware processor 102, at least one hardware memory 103, and one or more modules for performing different functions. Each module may include hardware, software, or a combination of both. Indeed, in some cases, a functional module may include a special purpose processor configured to perform a specific function. The special purpose processor may work with other hardware elements to perform a function defined by software code. This software code may be embedded in the hardware processor (e.g. an ASIC or System on a Chip) or may be stored in a separate location.

In addition to processor and memory hardware components, the computer system 101 may include a communications module 104 may be configured to communicate with other computing systems. The communications module 104 may include any wired or wireless communication means that can receive and/or transmit data to or from other computing systems including WiFi, Bluetooth, cellular or other radios. The communications module 104 may be configured to interact with databases, mobile computing devices (such as mobile phones or tablets), embedded or other types of computing systems.

The computer system 101 also includes an input receiving module 105 configured to receive inputs 111 from user 110. The inputs 111 may, of course, be received from other users or other computer systems. The inputs 111 may include parameters 112 which are used to identify music licenses. For example, user 110 may wish to purchase a license for a given media item such as a movie or song. The user may provide one or more parameters that will be used by the media license identifying module 106 to identify media licenses 114 stored in data store 113, or stored in some other data store.

In some embodiments, for example, user 110 may use a user interface 117 presented on display 116 to select the parameters 112 that are to be matched by the media license identifying module 106. The user interface 117 may include different fields (e.g. license information field 118) which are used by the user to select parameters, select licenses, view license information, or perform other functionality. For instance, the license information field 118 may be configured to display information relating to one or more media licenses 114. The license information may include details about the media item such as its title, license owner, album, publisher, release date, track code, union talent indication, exclusivity indication, content type, description of the media item, composer, tempo, length, similar media items or other information. Indeed, it will be understood that may other types of detail information may be included in addition to or as alternatives to the above-identified items.

The user interface 117 may include other fields such as a media license type selection field 119 that allows the user 110 to select which type of media license the user wishes to purchase. Many different types of licenses or “clearances” may be purchased. For example, the user 110 may wish to purchase a non-broadcast license, or an internet license, a license for broadcast commercials or broadcast programs, a license for a public venue, a license for a film, or a license for a commercial package. Again, it will be understood that other types of licenses not identified above may be presented and/or purchased using user interface 117.

The license price field 120 may show the price of a selected license. Each type of license may have a different price. This price may be set by the owner of the corresponding media item or by another entity. In some cases, the price may be dictated by or at least partially subject to current market prices. These prices may be determined by a third-party agency or by some other entity.

In other cases, the content provider or content owner may upload their own content and establish their own price for that content. If the content provider or owner does not want to indicate a cost for a clearance for their content, then they may indicate such in a variety of different ways. In such cases where a cost is not supplied by a content provider or owner, when a customer attempts to view the clearance and its associated price, the letter or symbol in the “Price” field may indicate that a quote is to be requested. This quote may be requested automatically, or may first query the customer for input verifying their desire for a quote.

Thus, a customer may use the user interface 117 to select one or more clearances. If the clearance does not have a price, the system (e.g. 101) may provide inputs that guide the customer to request a quote. After the customer has requested a quote, the content provider or owner receives a notification that the customer has requested a quote. The content provider or owner then enters a cost for the clearance. The input receiving module 105 of computer system 101 then receives the cost for the clearance and, at least in some embodiments, adds a transaction fee (e.g. 15%) on top of the indicated cost or deducts the amount of the transaction fee from the total fee. The quote is then shown to the customer. The customer can accept or deny the quote and, if the quote is accepted, the content provider or owner can indicate to the computer system 101 to create an invoice between the customer and the content provider. Both parties may then receive hard or soft copies of the invoice. Soft copies, (i.e. electronic copies), may he transmitted directly to the user in the form of a word processing document, a spreadsheet, a portable document format (PDF) document or some other electronic form. Hard copies may be sent via traditional postal mail. As such, content providers or owners can withhold license costs initially, and then provide them later on demand when the customer asks for such.

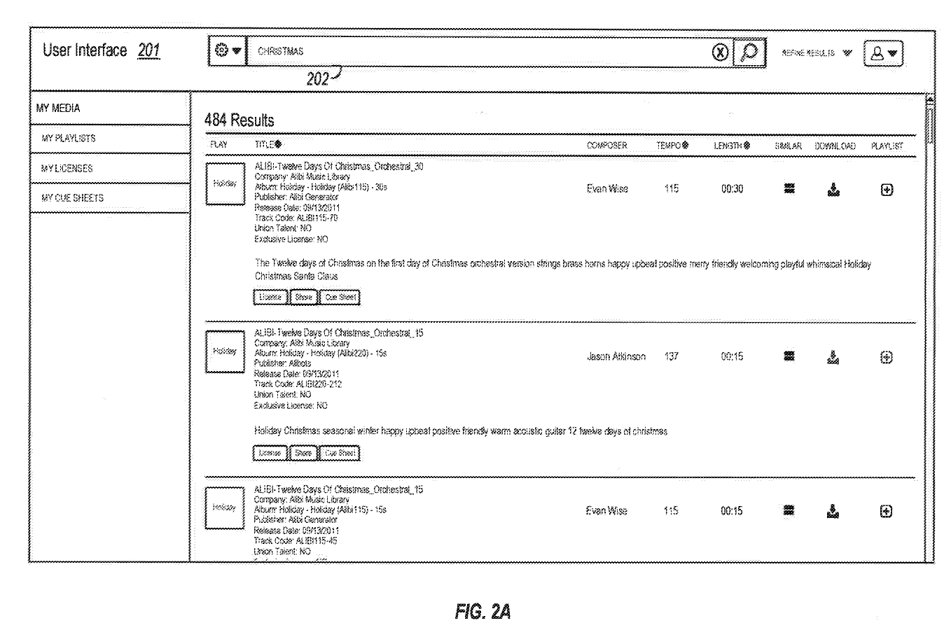

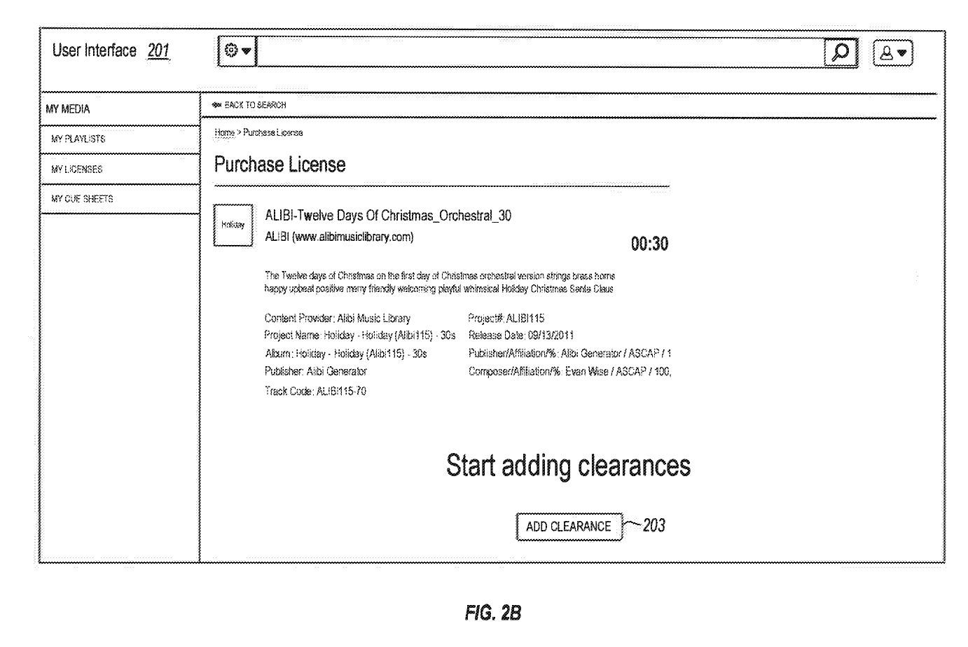

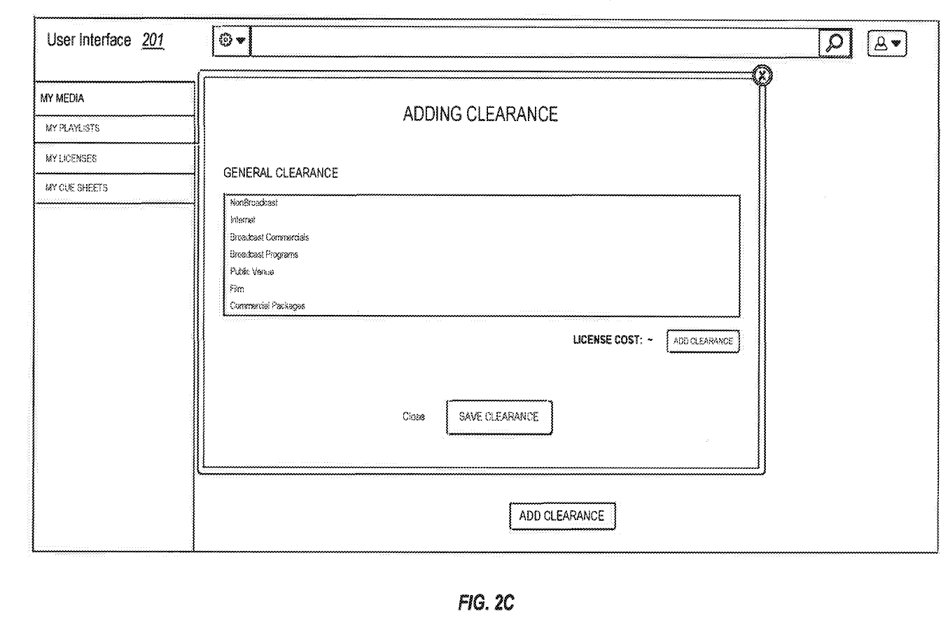

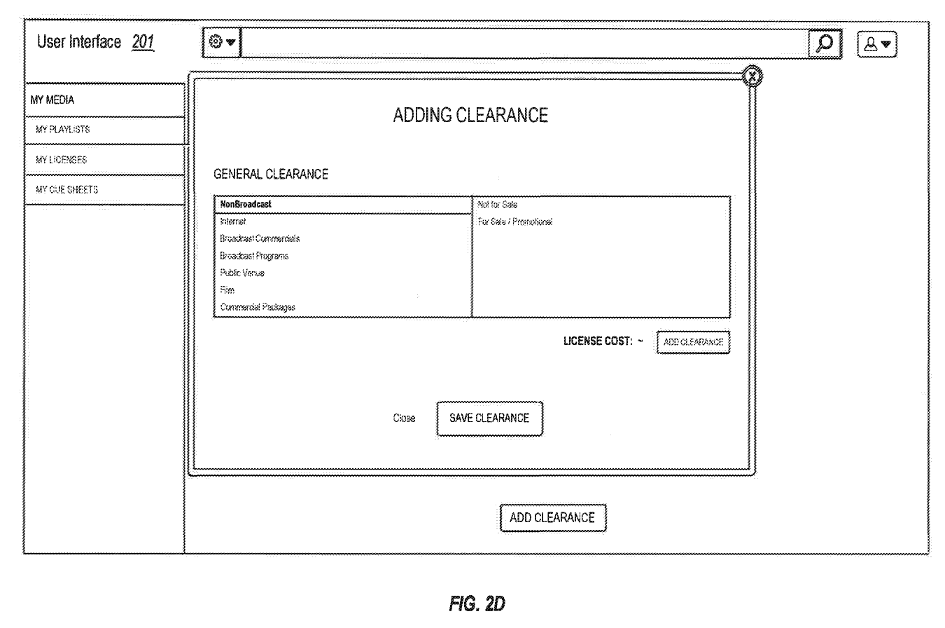

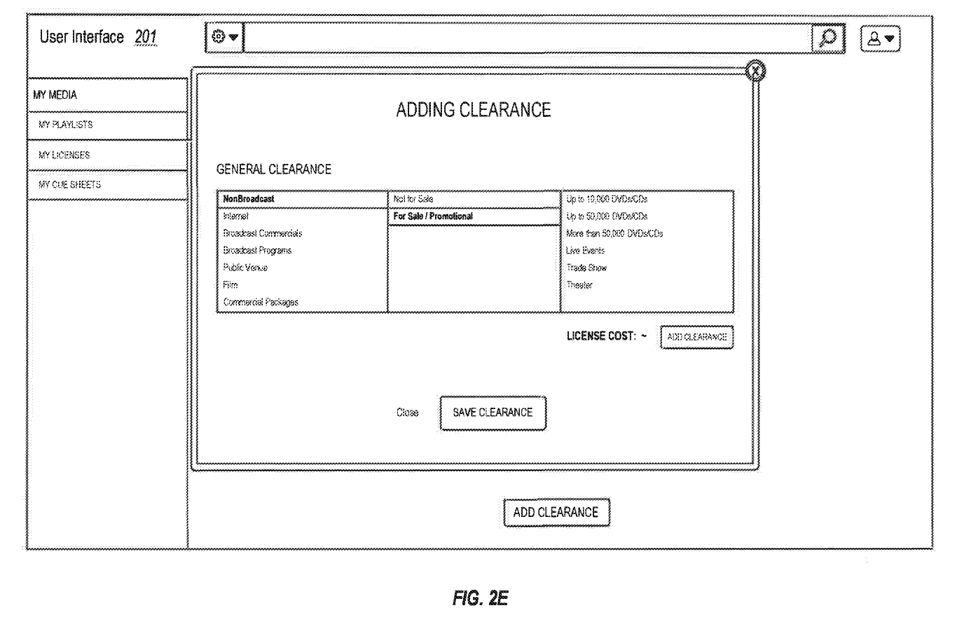

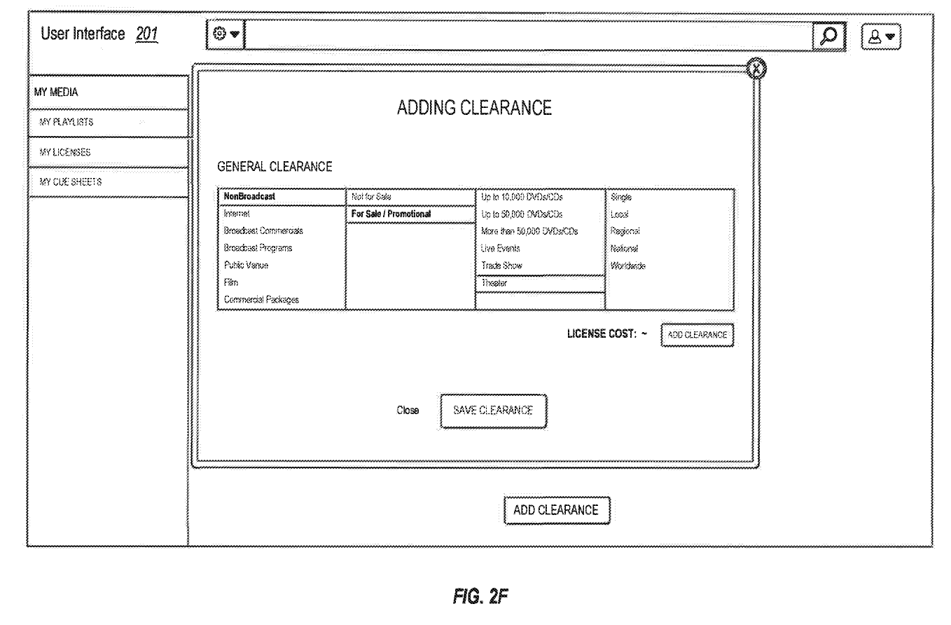

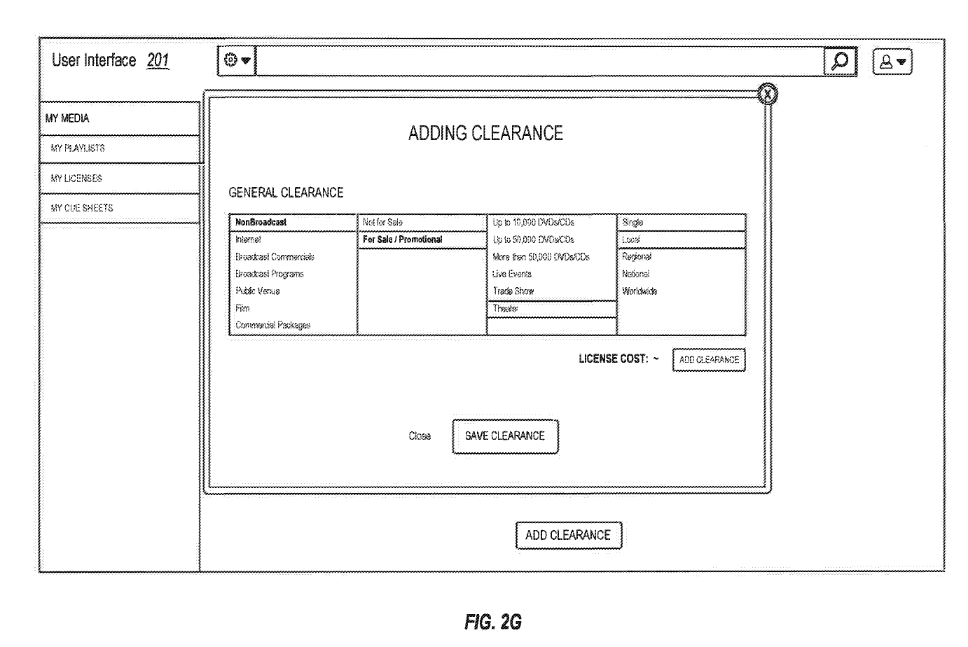

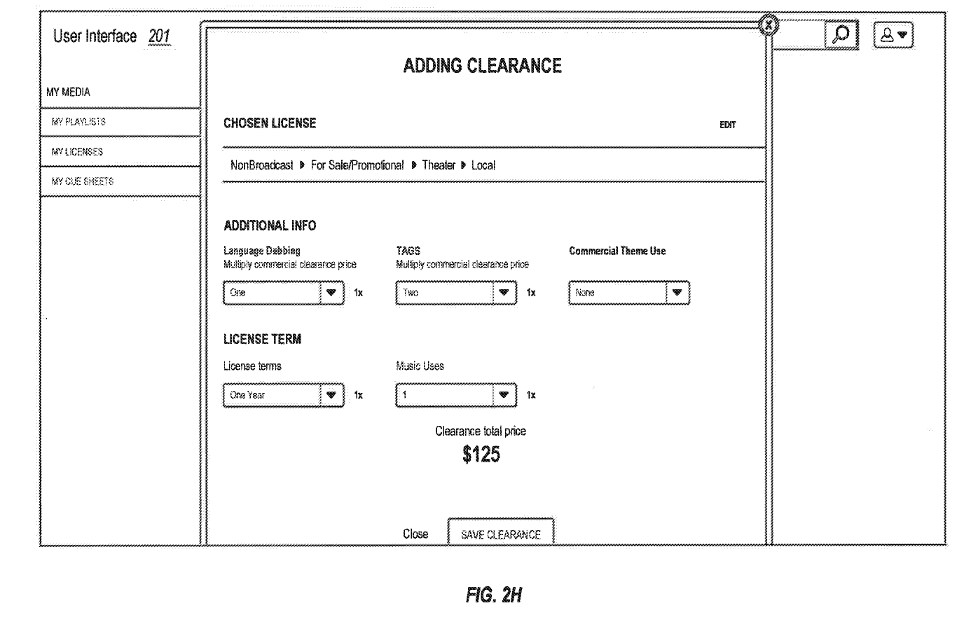

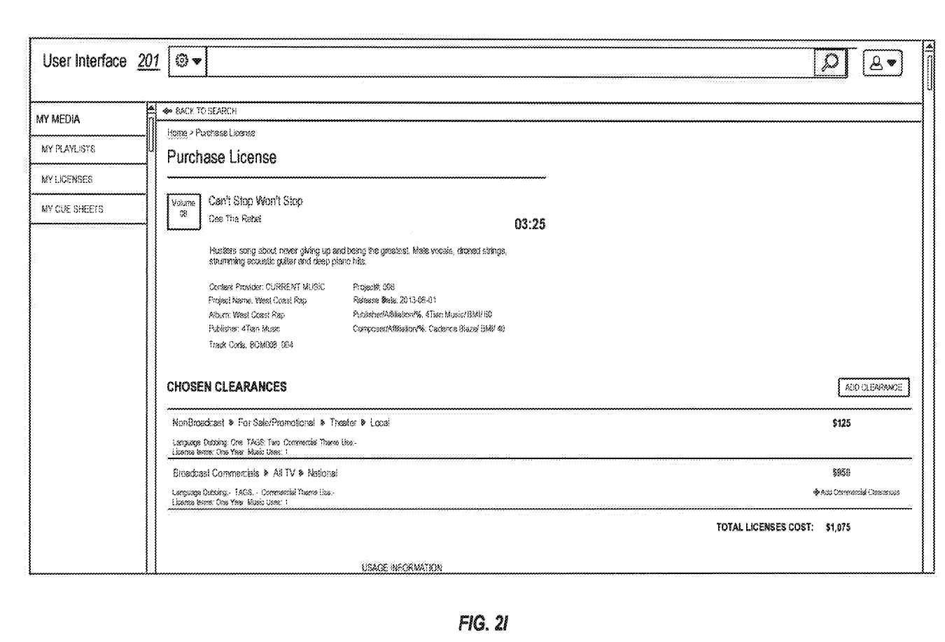

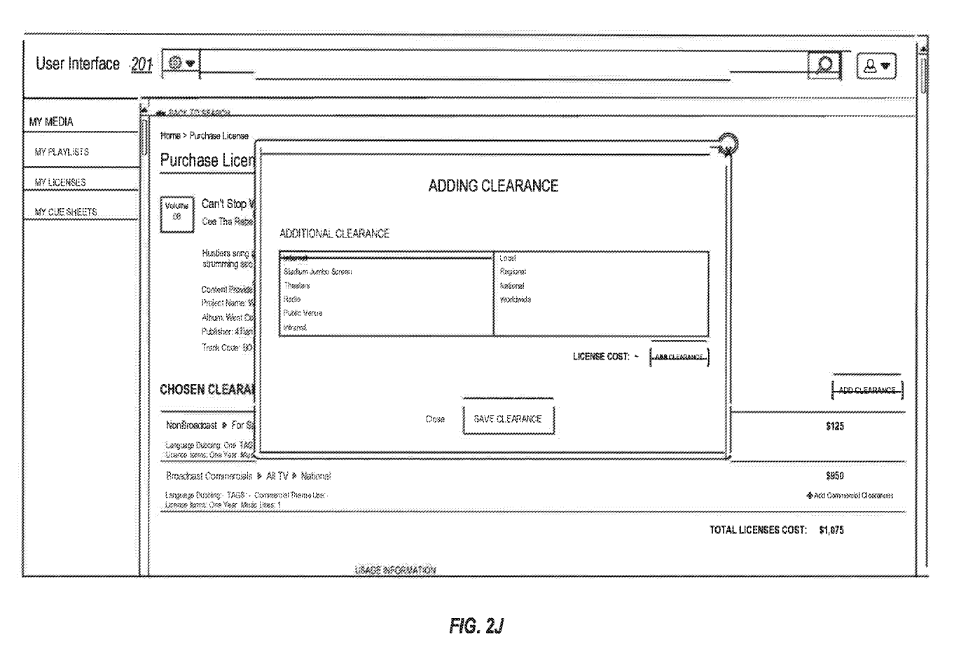

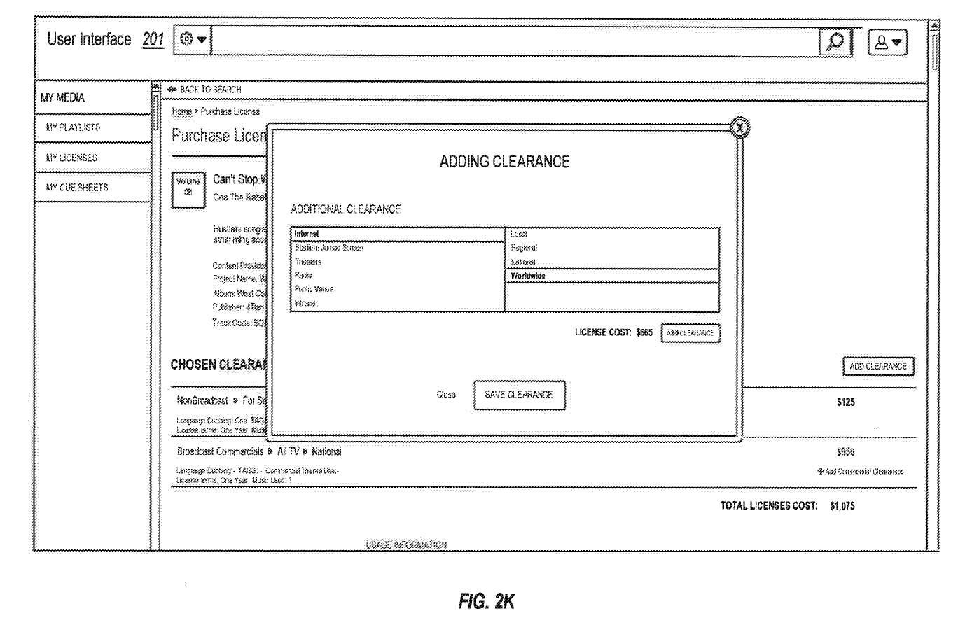

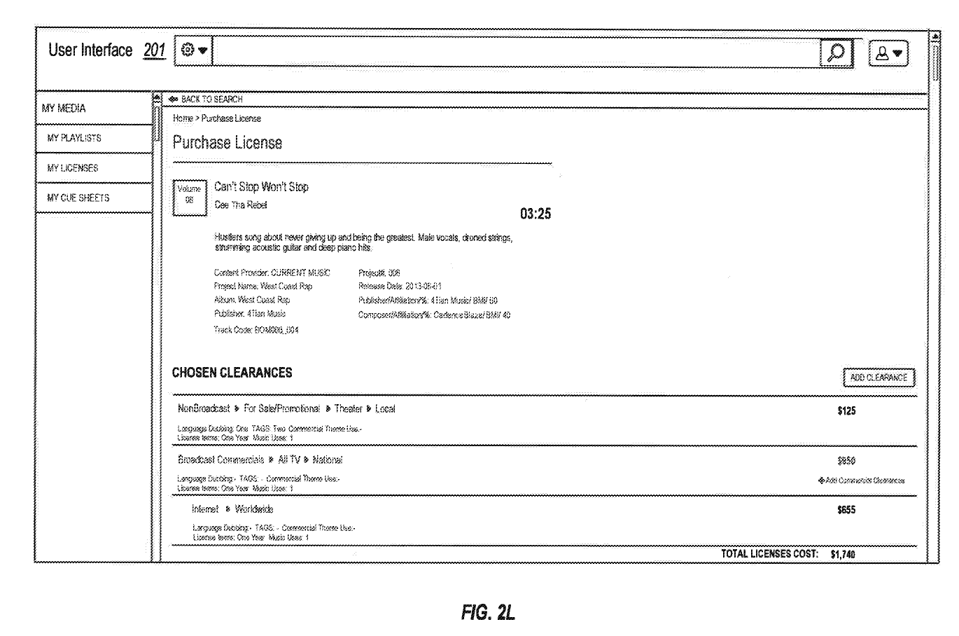

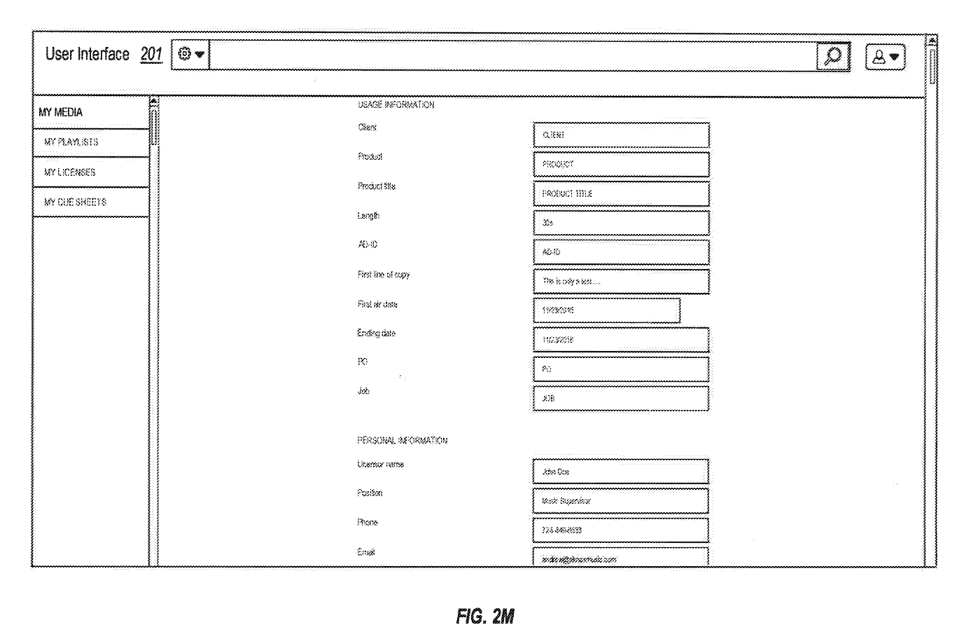

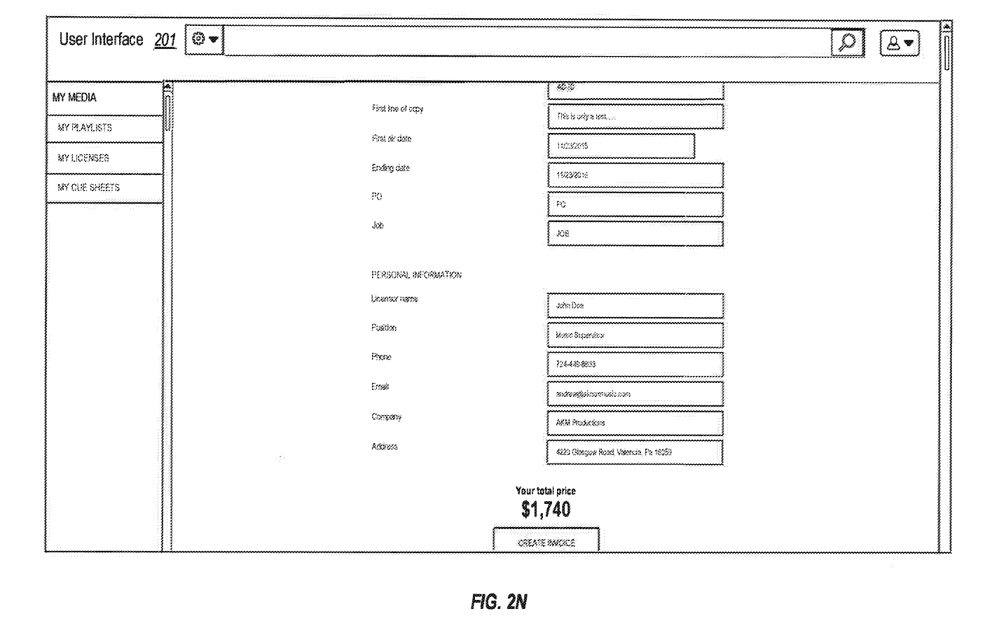

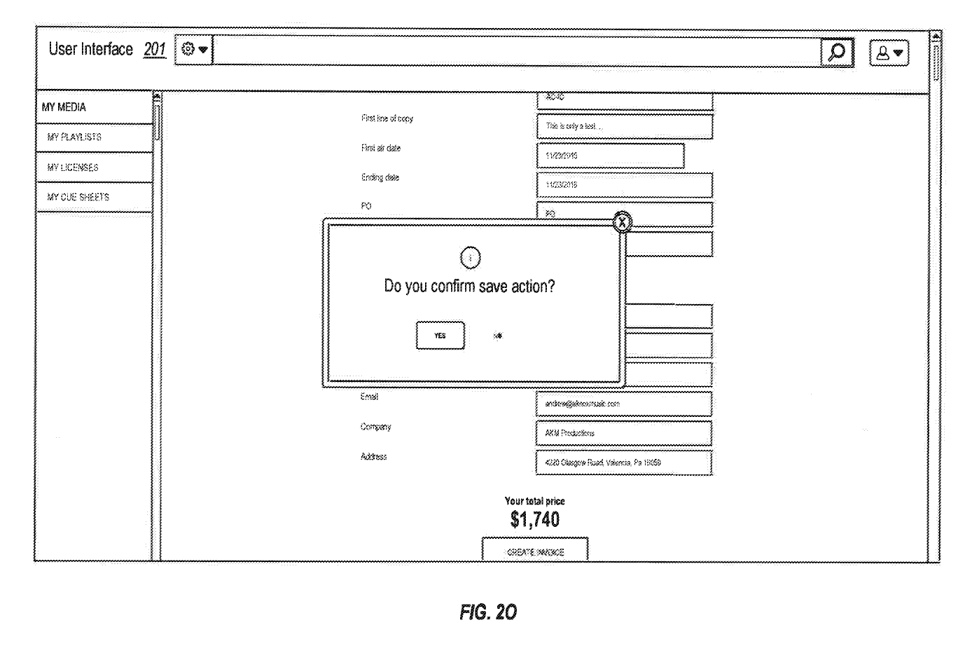

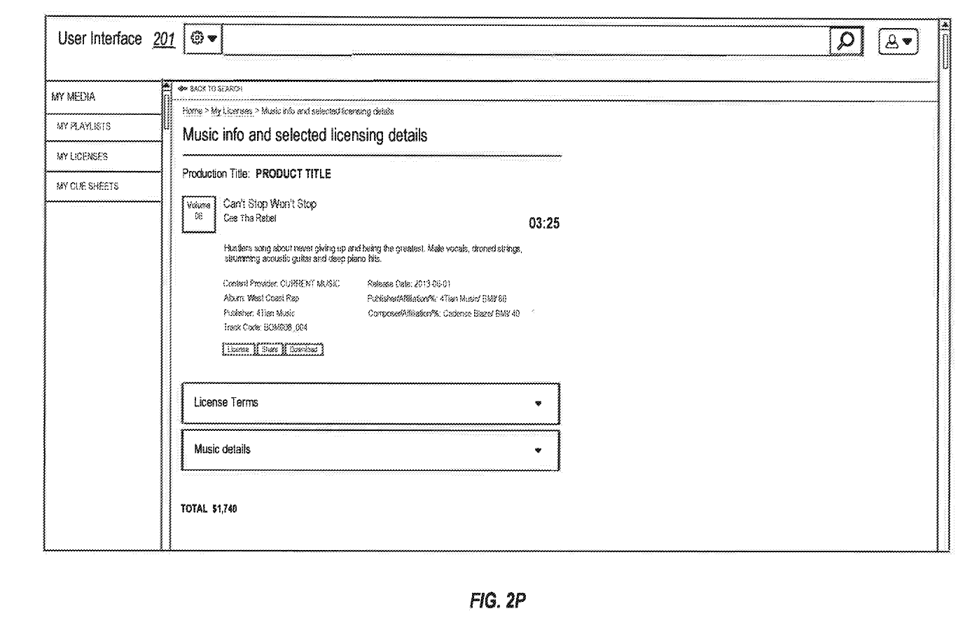

Once the final prices have been determined for the licenses, the payment processor UI element 121 may allow a user to initiate payment for the license(s). The UI 117 may display those licenses that are to be purchased by the user. This may be a single license or multiple licenses, and may include a specified collection of licenses 122 that, at least in FIG. 1, includes licenses A, B and C. The UI 117 and its corresponding elements will be described in greater detail below with regard to FIGS. 2A-2P.

One embodiment herein is a computer program product that includes one or more computer storage media that have computer-executable instructions stored thereon. When executed by one or more processors of a computing system, the computer-executable instructions cause the computing system to instantiate a user interface (e.g. UI 117). The UI includes a license information field 118 configured to present information relating to identified media licenses 114. The UI also includes an actionable element (e.g. media license type selection) that allows selection of the type of media license to be acquired by a user for a selected media item.

As shown in FIG. 2A, user interface 201 includes a list of media items that match the search term “Christmas” as indicated in search bar 202. In the Results area, 484 media item results are indicated as matching the term “Christmas.” Only the first three results are shown in the Results area. Each media item has multiple portions of information shown in the license information field 118. This information may include the media item's title, license owner, album, publisher, release date, track code, union talent indication, exclusivity indication, content type, description of the media item, composer, tempo, length, similar media items or other information. The UI user 110 may scroll through the list of media items to identify which they may be interested in licensing.

In FIG. 2B, the user is shown as having selected “ALIBI-Twelve Days of Christmas_Orchestral,_30.” From this screen, the user may review additional license information related to the media item, and may also add clearances by selecting the “Add Clearance” button 203. Selecting button 203 brings the user to the UI screen shown in FIG. 2C. In the Adding Clearance window, the user may choose from the various license types available for that media item (e.g. via media license type selection field 119). The license types may include non-broadcast, internet, broadcast commercial, broadcast program, public venue, film, commercial package, or other license types. The “License Cost” field may indicate the price of each license type when that license type is selected. For example, if the user 110 selected an “Internet” license, the cost for the internet license would be shown in the License Cost field. From here, the user could either add the license to their collection of licenses that are to yet to be purchased, or could exit out of the window and view other media items.

FIG. 2D illustrates an example where the user has selected a non-broadcast license. Within the non-broadcast license, other options are also presented including “Not for Sale” and “For Sale/Promotional.” Different prices may be associated with non-broadcast licenses for media items that are for sale or are promotional versus items that are not for sale. Again, the price for each license type may be shown in the “License Cost” field. In some cases, licenses may be geographically limited to one or more given countries (e.g. to the United States or to Canada). International or worldwide licenses may also be available. Each country may have its own license cost associated with it. Or, in some cases, multiple countries may be available together in a package deal. In some cases, the pricing may also depend on the origin of the media item, or the country in which the licensing user 110 is based.

Thus, as shown in FIG. 1, the UI 117 may include a license price field 120 that displays a determined price for the selected type of media license (whether domestic, international, for sale, not for sale, etc.). The price for each license type may be manipulated and/or modified for each user. Thus, depending on a variety of factors including identity of user, location of user, license purchasing history, current market demand, time of year (e.g. higher prices for Christmas songs during Christmas time), or other factors. The price for each license may be determined by preset market figures or current consumer demand. The price may also be set by machine learning based on comparable licenses and market demand in the user's local market or in the worldwide market. In this manner, the pricing may be dynamic and individualized for each user.

The UI 117 also includes a payment processor element 121 that is actionable to process payment for the type of media license selected by the user 110. The payment processor may be linked with banks or credit card companies to process payments. Any purchased licenses are added to a collection of media licenses 12 that includes the recently purchased media license and any other previously purchased media licenses. The user 110 may be able to scroll through or search their purchased licenses for a specific license or license type.

FIG. 2E illustrates an embodiment where the user 110 has selected a non-broadcast license for media items that are for sale or are promotional. Within such licenses, more options may be displayed in UI 201 including an option for up to 10,000 DVDs/CDs, up to 50,000 DVDs/CDs, more than 50,000 DVDs/CDs, live events, trade shows or for theater. Each of these options may have a separate cost for the license. In this manner, users may use UI 201 to purchase very specific licenses for each media item. If the user selects the “theater” option (see FIG. 2F), a further list of use types may be displayed including a single use, local use, regional use, national use or worldwide use. Again, each option may have a different price associated with it. As shown in. FIG. 2G, the price for a local theater license is $1,000. This license may be added to the user's shopping cart by selecting the “Add Clearance” button.

FIG. 2H shows an embodiment where a non-broadcast, for sale or promotional, local theater license has been selected by user 110. Additional information related to that specific license may be shown in the UI 201. For example, language dubbing options, tags, commercial theme use options, license term length and music uses, among other items, may be shown in the Adding Clearance window of FIG. 2H. Each option may add to or subtract from the total price. Presently, the selected license is $125.

FIG. 2I shows an embodiment of UI 201 where two clearances have already been added to the user's shopping cart. The first is a non-broadcast, for sale or promotional local theater license for $125, and the second is a broadcast commercial, all tv, national license for $950. The user is also viewing a media item “Can't Stop Won't Stop” with its associated media license information (i.e. the information shown in the license information field 118). FIG. 2J shows that the user has opted to add clearances. In the “Adding Clearance” window of FIG. 2J, an internet license is selected, and options for local, regional, national and worldwide licenses are shown. FIG. 2K shows that the user has selected a worldwide internet license, and that the cost associated with that license is $665. FIG. 2L is similar to FIG. 2I, but also includes the worldwide internet license for $665 in the user's chosen clearances.

Once the user 110 has finished selecting licenses, they may view usage information as shown in FIG. 2M. The usage information may include a client name, product name, product title, length of the clip, ad identifier, first line of copy, first air date, ending date, PO, job identifier and personal information including licensor name, position, phone, email, company name, address, etc. Other usage or personal information may also be shown in the window of FIG. 2M.

FIG. 2N displays the total price for all of the selected licenses ($1,740 in this case), and FIG. 20 allows the user to confirm whether an invoice is to be created (e.g. by the payment processor 121 of FIG. 1). Upon selecting yes in FIG. 20, a Music Info and Licensing Details window may be displayed as shown in FIG. 2P. This window shows the total price for the selected licenses, and includes actionable elements “License Terms” and “Music Details” that, when selected, display the terms of the selected licenses, and also display one or more details associated with the media item. Thus, following the process outlined in FIGS. 2A-2P, a user of the UI 201 may select and purchase specific licenses for each media item. Each purchased media license may be placed in a searchable collection or playlist of licenses. Users can create customized playlists that include certain media items or types of media items, or include all the media items related to a certain project such as a television show or movie.

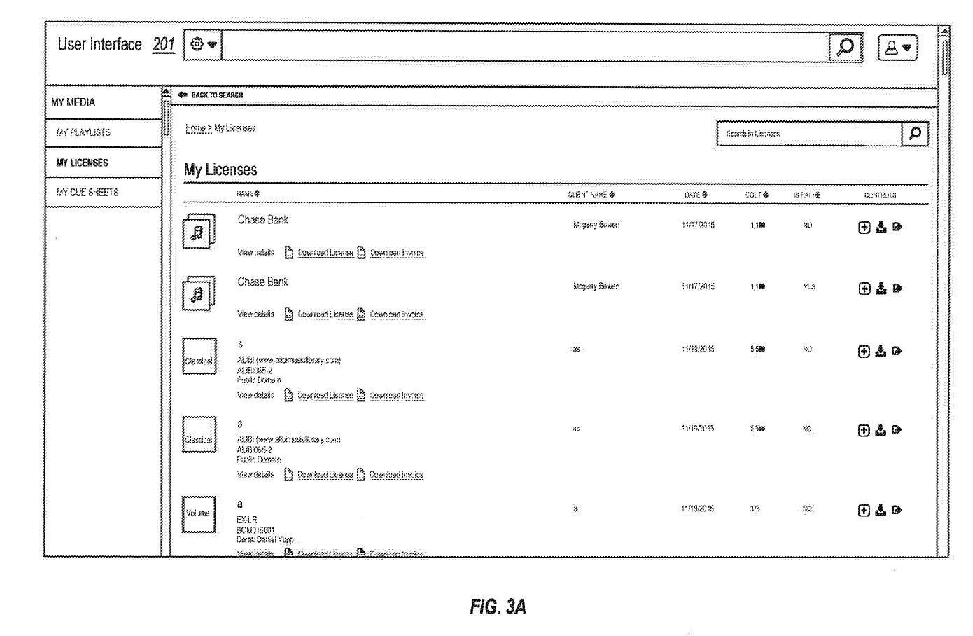

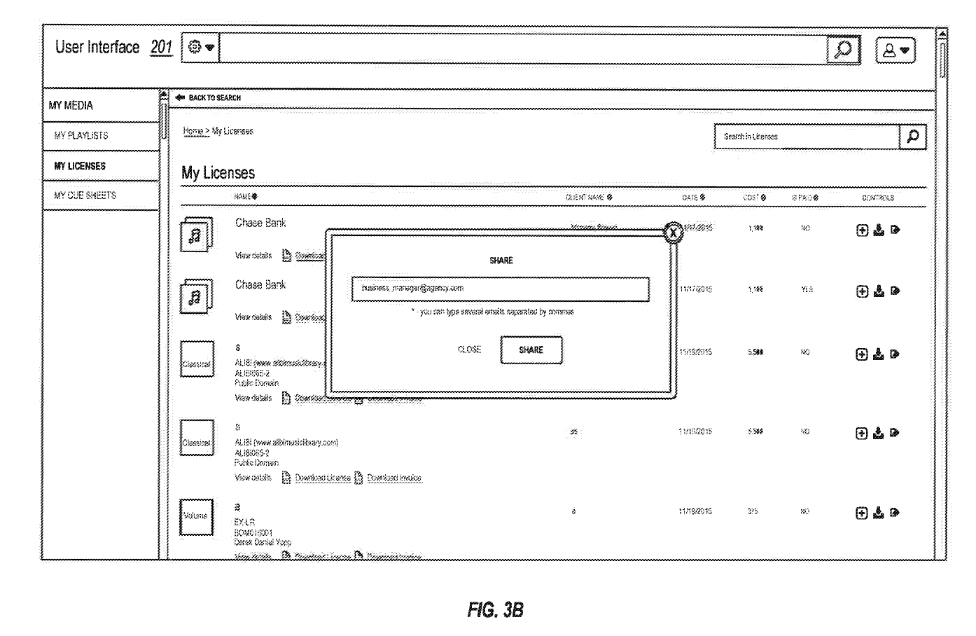

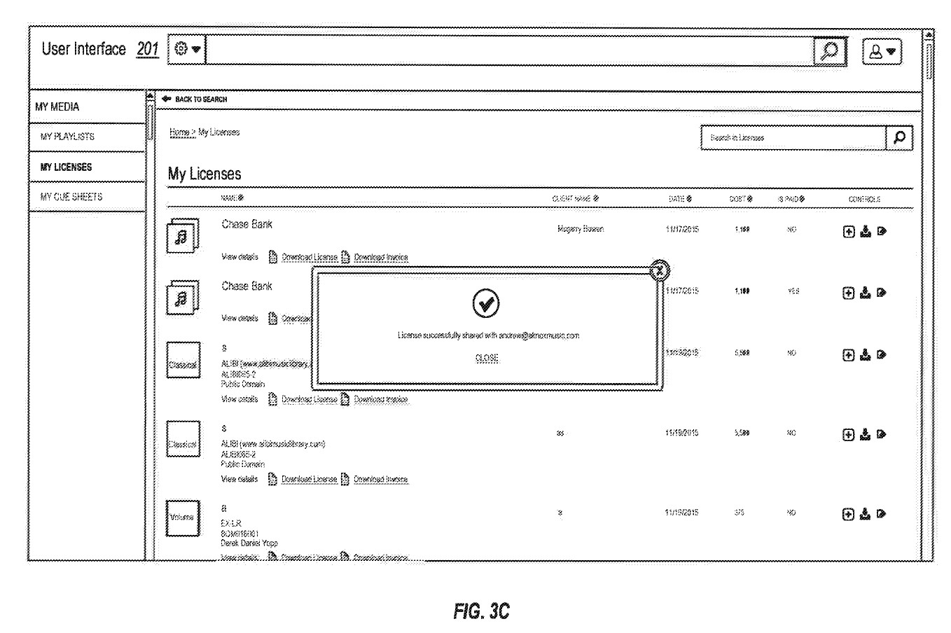

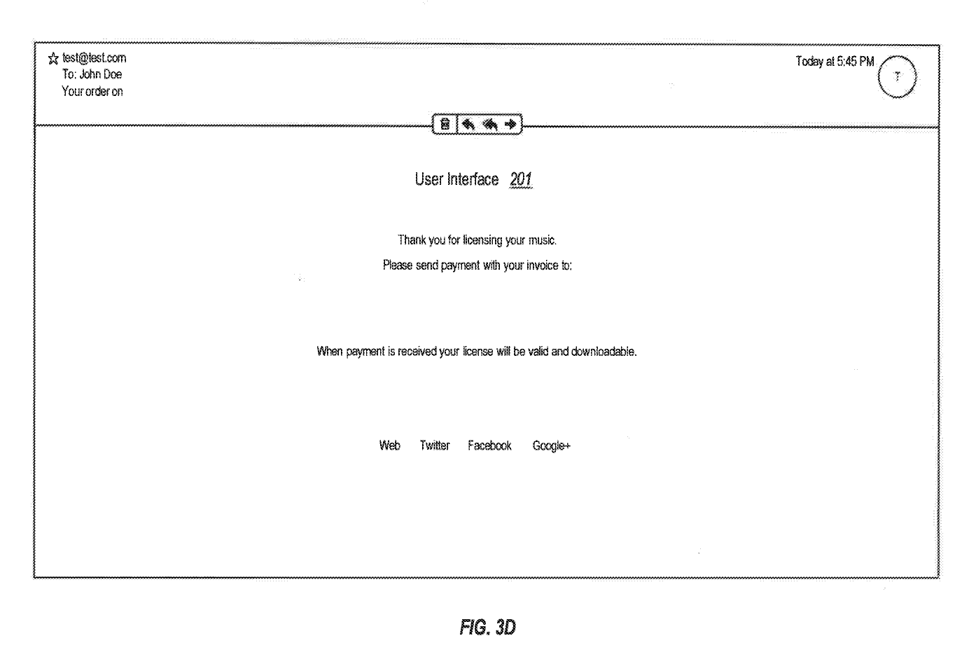

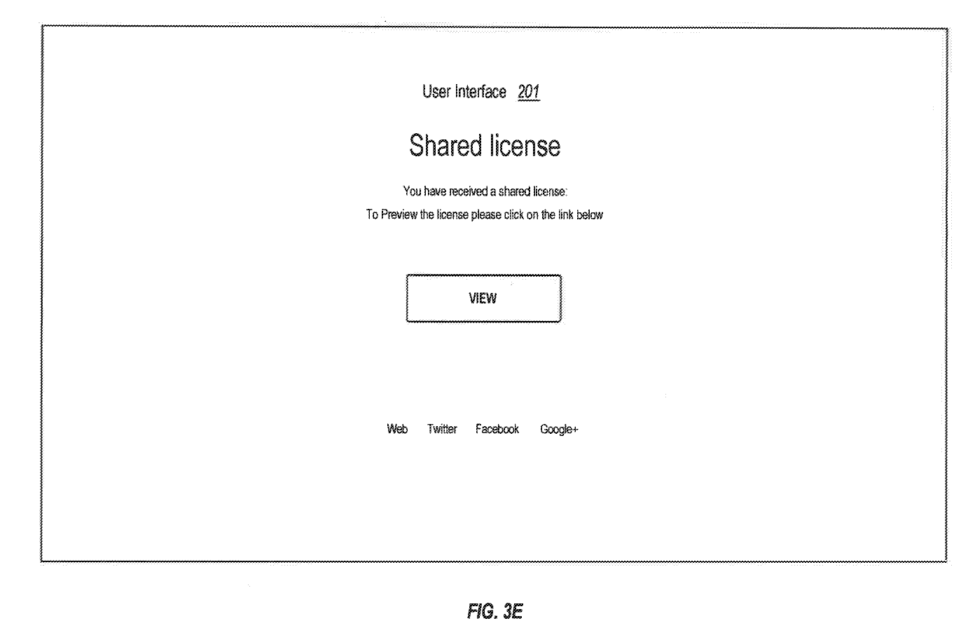

FIG. 3A illustrates an embodiment in which the user interface 201 is displaying a list of a user's purchased licenses. The list may include various licenses and license types. Each license may have information relating to the media licenses including a description of the media that is to be licensed. The UI 201 of FIG. 3A may, for example, include a UI field configured to present information identifying the owner of the media (e.g. Chase Bank). The UI may also be configured to show media items that are similar to a given media item. The UI 201 may, for example, show a list of songs that are similar to a selected song. The UI may provide actionable elements that provide access to a collection of media playlists associated with the user, to a collection of licenses associated with the user, to a collection of cue sheets associated with the user, or to other information associated with media licenses. The cue sheet, for example, may show for a given movie or television show, which songs or song snippets are to be used during an intro, scene change, montage, etc. Using a cue sheet, a user may be able to more easily manage which media items are associated with a given project such as a film or tv show.

The UI of FIG. 3A further provides options for a user to download a license or download an invoice associated with the media item. The downloadable license may be a full-form version of the license, including an identification of the media item and the terms of the license. The UI 201 may also provide controls that allow a user to share the license with other users. FIG. 3B illustrates an embodiment where a share license UI element has been selected. A window is shown in FIG. 3B which allows the user to enter the email address (or other contact information) of the individual with whom the user wishes to share the license. After providing the email address of the intended recipient, the selected media license will be shared with that recipient, as indicated in FIG. 3C. A “Thank You” screen may then be shown (e.g. FIG. 3D) along with information related to the purchased/shared license. The recipient of the shared license may receive an email or other notification (such as that shown in FIG. 3E) indicating receipt of the shared license. FIG. 3F shows an embodiment in which the recipient is viewing information related to the shared license.

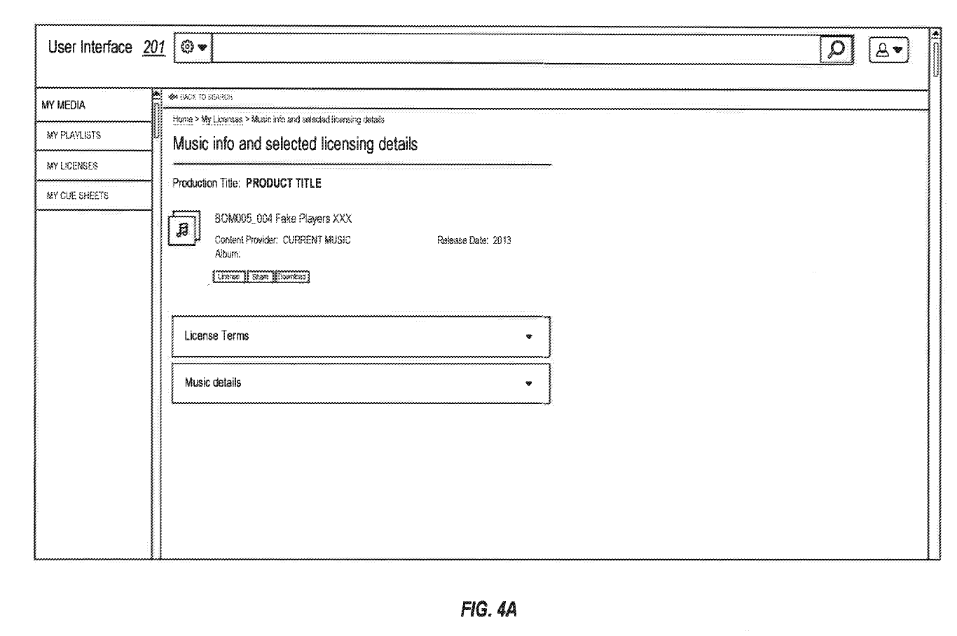

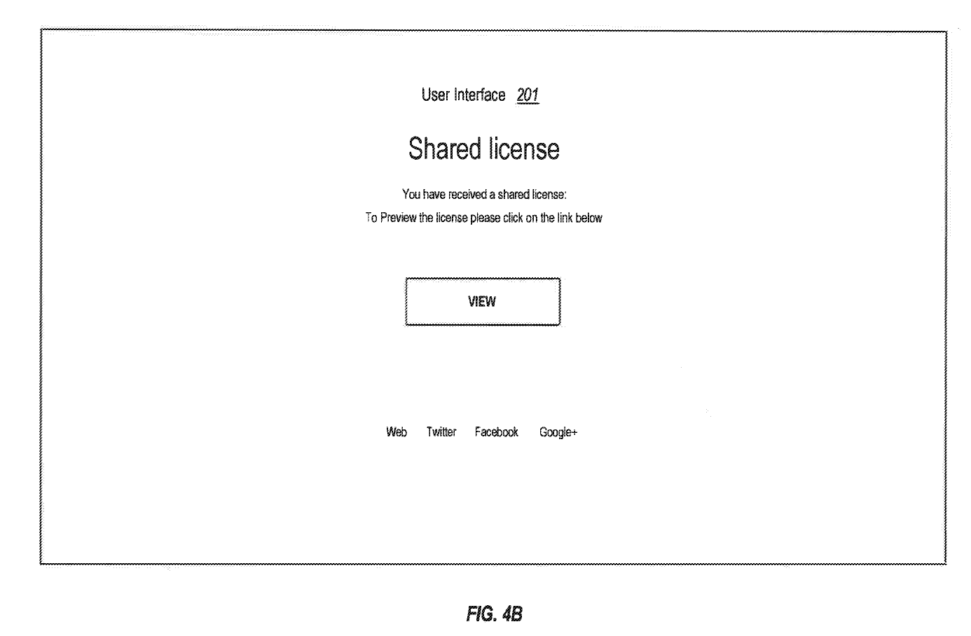

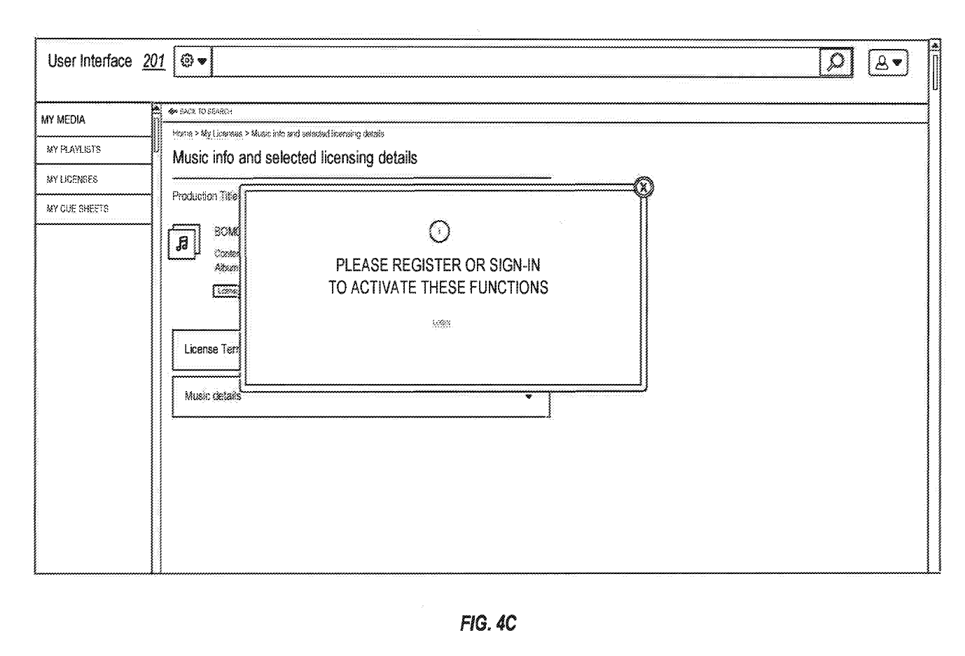

In another embodiment, the user may attempt to share a license with a user who is not yet authorized to view licenses. For instance, in FIG. 4A, the user may select to share a music track “BO MOOS_004 Fake Players XXX” FIG. 4B shows, on the recipient side, an indication that a license has been shared with that user. FIG. 4C illustrates a UI window that indicates to the recipient that they are to register or log in to view the license that has been shared with them. The UI element that allows the user to share a license may be substantially any type of button, field or other actionable element that allows the user to share acquired licenses with another user. The shared license may include any type of license including non-broadcast (with sub-options of not for sale, for sale/promotional (up to 10,000 CDs/DVDs, 10-50,000, over 50,000 CDs/DVDs, live events, trade shows, theater (single, local, regional, national, worldwide), internet, broadcast commercials, broadcast programs, public venues, film, commercial packages, radio, stadium jumbo screen, public venue, transit or other license type. Each license type may also be local, regional, nationwide, or worldwide. Accordingly, many different license types and scopes are possible.

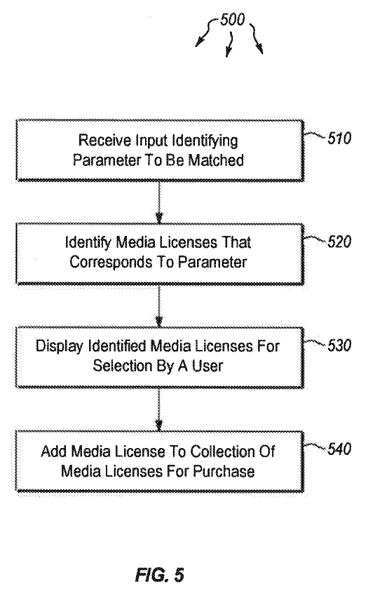

These concepts will be explained further below with regard to method 500 FIG. 5. In view of the systems and architectures described above, methodologies that may he implemented in accordance with the disclosed subject matter will be better appreciated with reference to the flow chart of FIG. 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 illustrates a flowchart of a method 500 for identifying and presenting media licenses base on parameters. The method 500 will now be described with frequent reference to the components and data of environment 100.

Method 500 includes receiving one or more inputs identifying at least one parameter that is to be matched to one or more different media licenses or media license types (510). For example, in FIG. 1, the input receiving module 105 of computer system 101 may receive input 111 identifying one or more parameters 112 that are to be matched to different media licenses 114 or media license types 115. The parameters may include media type, media item name, producer, owner, length or other type of parameter. Using these parameters, the media license identifying module 106 may identify media licenses 114 that correspond to the parameters (520).

Method 500 further includes displaying the one or more identified media licenses for selection by a user (530). For example, the display module 107 may display the identified media licenses in user interface 117 of display 116. The media licenses are displayed in a license information field 118 that includes various portions of information related to the media item. The media license type selection LI element 119 allows the user 110 to select which media license or license type they wish to view and/or purchase. Upon selection of the media license by the user, method 500 includes adding the media license to a collection of media licenses 122 that are to be purchased (540). The collection of licenses may be searchable and organizable by the user, so that various licenses are shown based on parameters or preferences provided by the user.

In some embodiments, the inputs 111 provided by the user 110 that identify one or more parameters 112 further include a project description. The project may be a television show, movie or other portion of media that involves multiple media licenses. As mentioned above, for example, a movie may include many different songs or song snippets. Each use of a song may be entered into a cue sheet corresponding to that movie. In cases where the parameters 112 input by the user are related to a specific project, identification of the media licenses that correspond to the parameters may include identifying media licenses that correspond to the project description. Thus, if the project is a film, and the film description has various terms in it, the parameters identified by the user may be matched against those terms.

The user interface 117 of display 116 may display the media licenses in the collection of media licenses 109 according to media license type. As such, all media items with a specified license type may be displayed in the user interface. In some cases, each of the media licenses that are associated with a given media item may be displayed in the UI 117. In such cases, a single media item may be displayed with multiple media licenses of different types that are associated with the first media item. When these media items are displayed, one or more portions of license usage information may also be displayed in the user interface 117. If changes are needed in the license usage information, it may be dynamically updated in real time. This information may include pricing information, which may also change and be updated in real time. User interface users may also cause the UI to display license terms for a selected media license, including license type and valid term.

One embodiment described herein includes a computer system itself. The computer system may include the following: one or more processors 102, a display 116 for displaying information relating to one or more identified media licenses 114, an input receiver 105 for receiving input 111 indicating that a specified type of media license is to be acquired by a user 110, and a price calculating module (which may be part of the license management module 108) that determines a price for the selected type of media license. The display 116 displays the determined price for the selected type of media license, and a payment processor 121 causes payment to be processed for the selected type of media license. The purchased media license is then added to a collection of media licenses 109 including the purchased license and any previously purchased media licenses.

The user interface 117 of display 116 may further display an actionable element in the user interface that, upon selection, displays media item details associated with a selected media item. The UI 117 may also include one or more actionable elements for language dubbing, tags, commercial theme use, license terms, music uses or for performing other related functions. The price for each license may be market-demand driven or set by a specified entity. As such, the pricing structure for the media licenses may change dynamically according to market demands or according to changes made by the specified entity. The III 117 may provide an indication of whether the media license has been paid for by the user, or has merely been added to a cart for later payment.

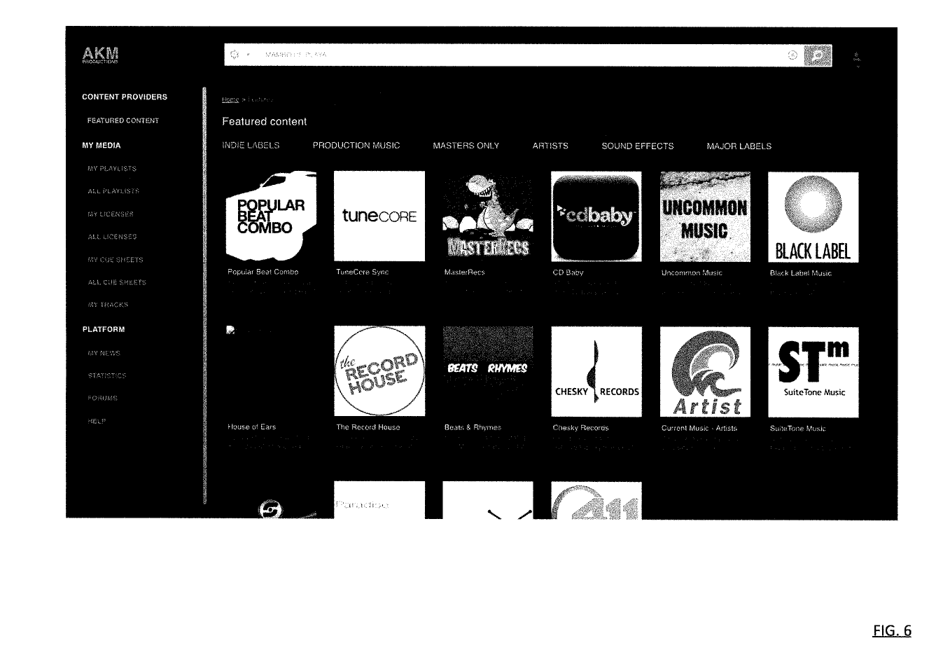

In various embodiments, the tools and techniques described herein provide content search capabilities and licensing services to many different enterprises and other users 110. Searches can be conducted for a variety of content (e.g., music, videos, text, etc.) on many different websites and other data sources to find a suitable track of music, for example, and to create a playlist on a computing device. In certain embodiments, the invention offers a cloud-based platform that allows users to search and obtain licenses from many different music companies, for example, through a single platform. As shown in the example screen display of FIG. 6, the user 110 can access the computer system 101 to view individual content provider information, such as curated playlists, and content can be provided in association with independent labels, production music, master only, artists, sound effects, and major record labels.

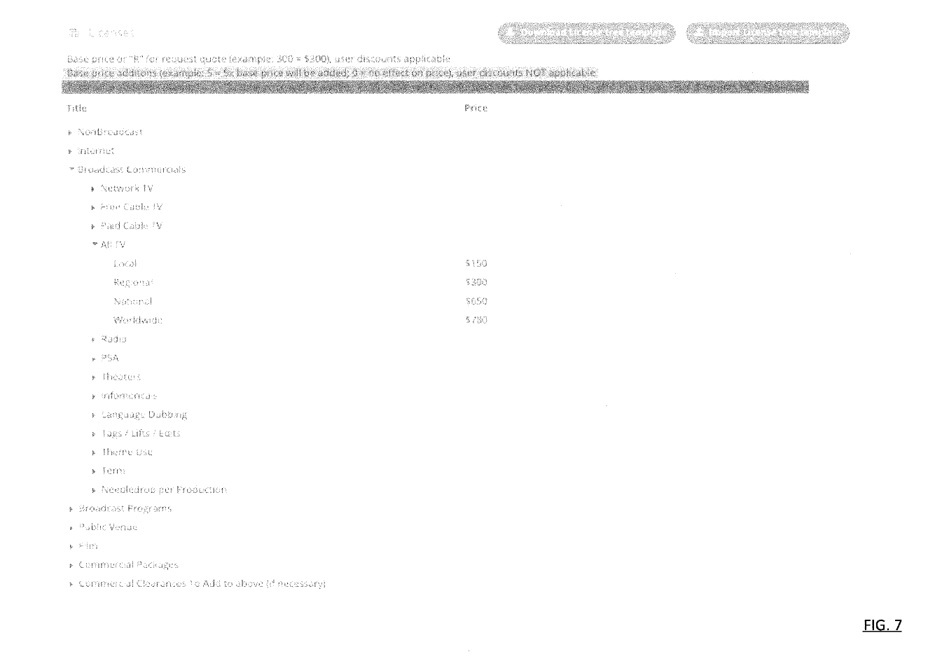

With reference to FIG. 7, during the onboarding process of a new content provider to the computer system 101, a spreadsheet or equivalent document can be used to enter license rates for content. Once this document is completed, the content provider can upload the document to the system 101, which is programmed with a module to convert and display the completed rate card on the user interface 117. In certain aspects, each content provider can display their own rates for their music, video, or other content, and they have the ability to change their rates. The system 101 can also be programmed to allow entry of predetermined special discounts for individual users 110, so their license costs are displayed with the discounted rate rather than the full rate card rate.

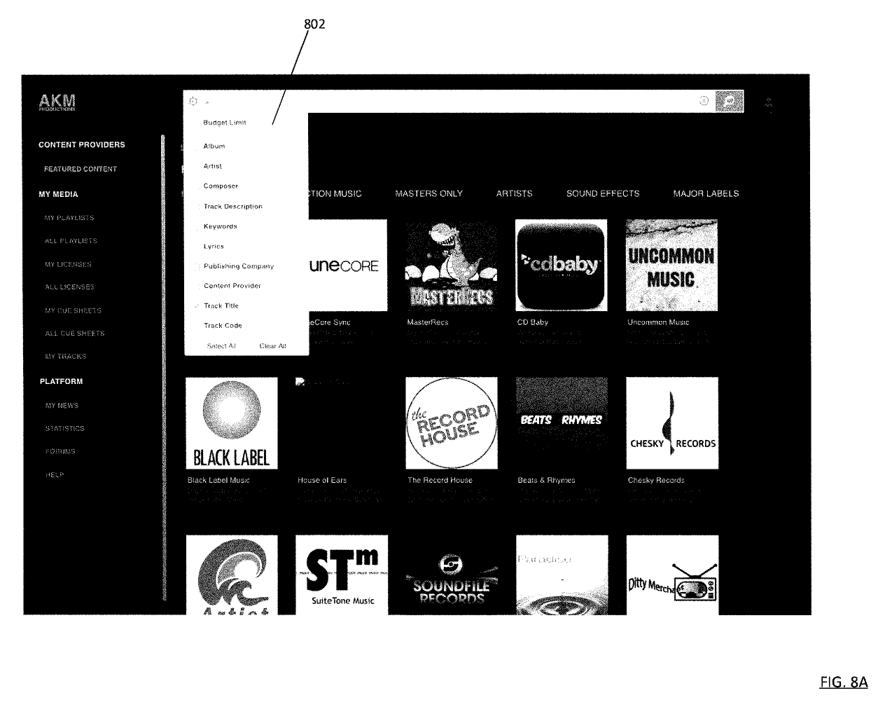

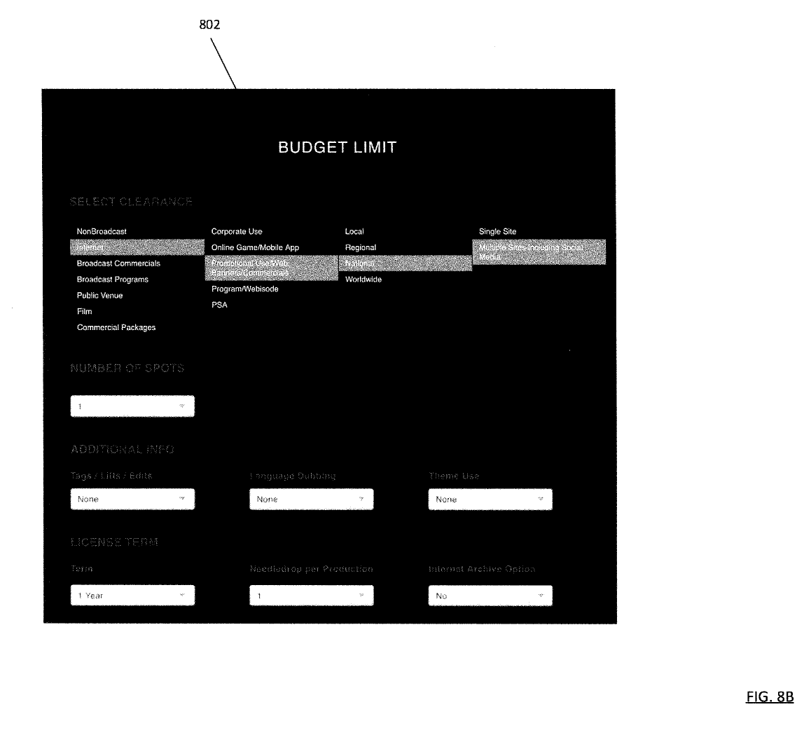

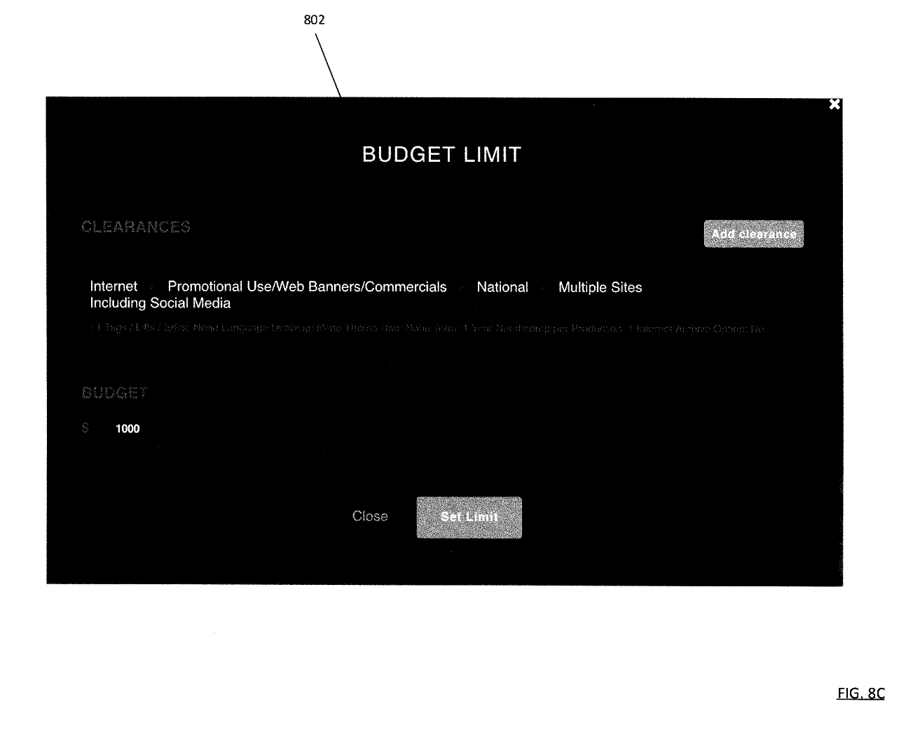

With reference to the screen display examples shown in FIGS. 8A-8C, because each content provider has its own dictated rates, a budget filter tool 802 can be provided to walk the user 110 through various steps of determining a budget for licensing costs. This allows the user 110 to pick the license clearance they want and to account for potential budgetary limitations. The system 101 can be programmed to search and retrieve rate card data and return valid search results in response to this specified budgetary limit.

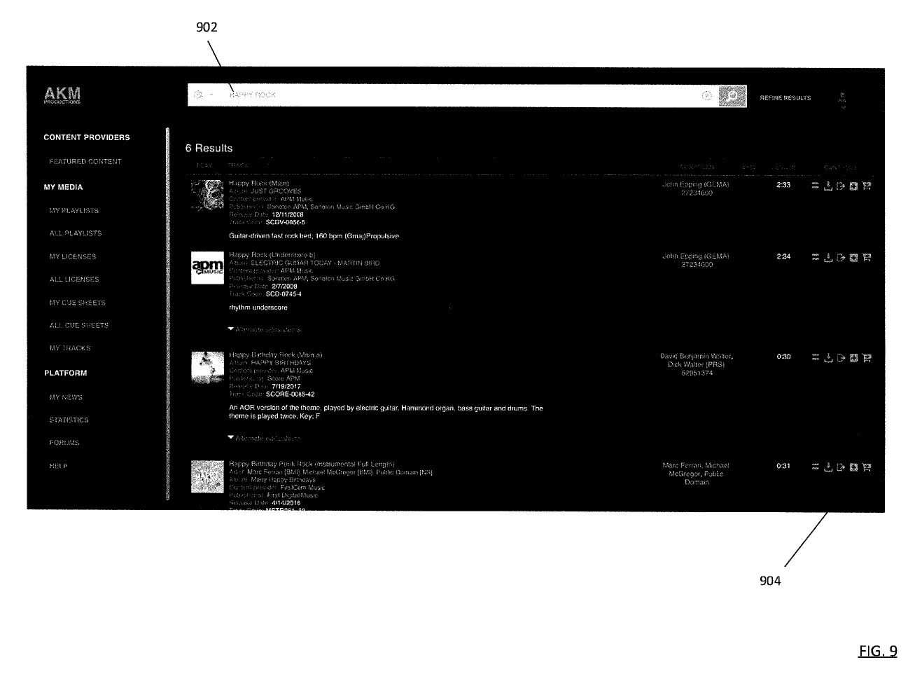

FIG. 9 includes an example of a screen display showing the results of a search completed by the system 101, displaying only the tracks meeting specific parameters, such as the “Happy Rock” search term as shown. It can be seen that this search takes into the account the rate cards which content providers have supplied to the system 101. The user 110 is empowered to select many different tracks from different content providers with different rate cards all through a single filter. In this example, only six focused results have been returned for a few content providers derived from a pool of potentially millions of tracks of music and possibly hundreds of different content providers. By select a shopping cart icon 904, the user 110 can then proceed with licensing the selected track.

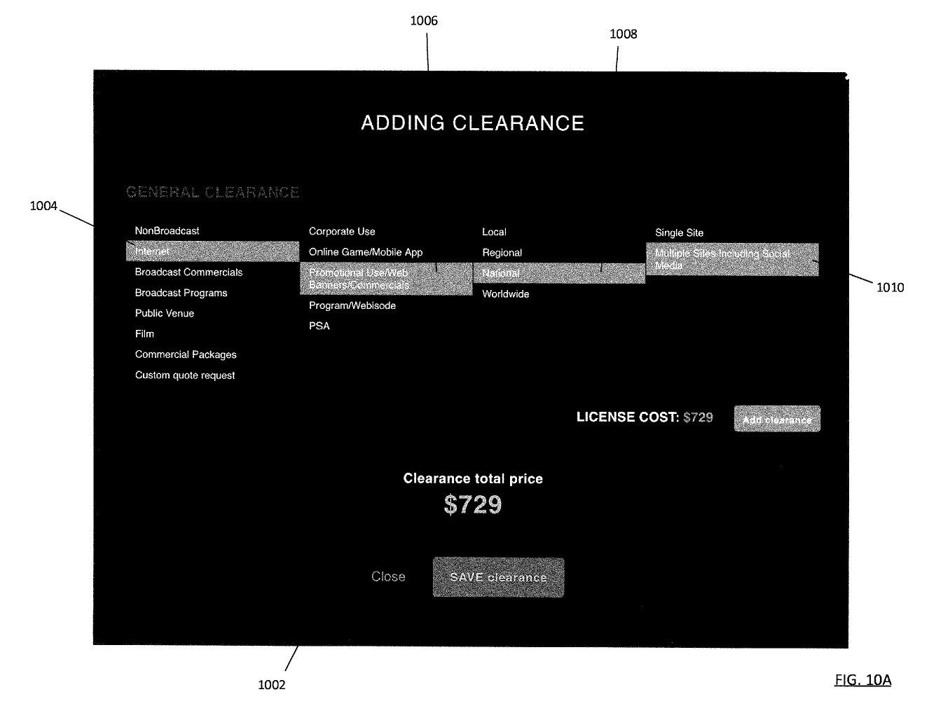

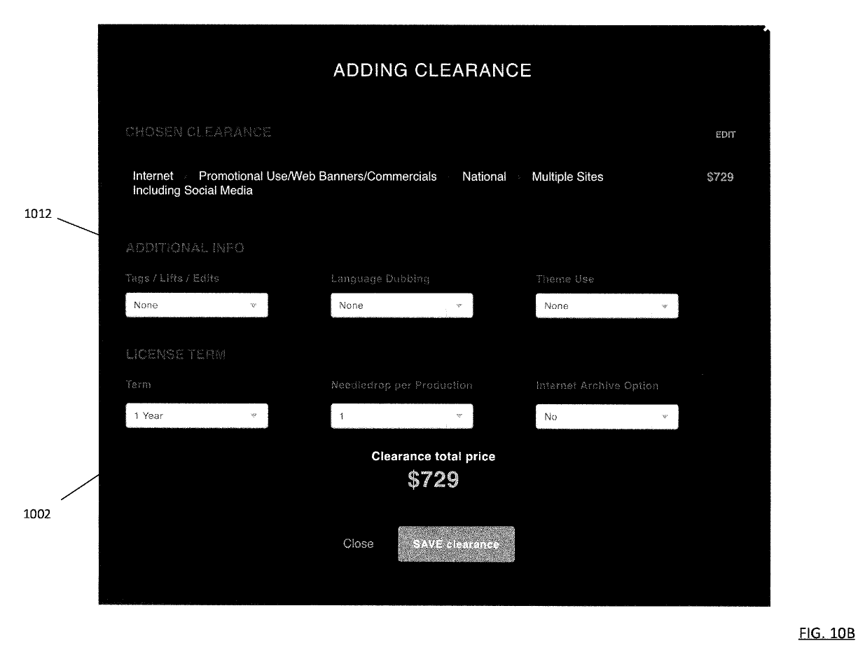

In certain embodiments, the user 110 can be guided through the licensing process by selecting an adding clearance tool 1002, an example of which is illustrated in FIGS. 10A and 10B. Based on a budget limit selected using the application of the budget filter tool 802, an actual cost of the license is now reflected in the license management module 108 of the system 101. As shown in the example of FIG. 10A, the user 110 can enter license clearance information such as broadcast medium 1004, use type 1006, geographic scope 1008, and/or site type 1010. As shown in FIG. 10B, the user can specify various other kinds of additional information 1012 which may be relevant to the licensed content. At the next stage, an invoice can be created and displayed by the system 101 to the user 110. During this stage, both the user 110 and any relevant copyright holders can be notified regarding the request for a license for the content in accordance with the specified clearance data.

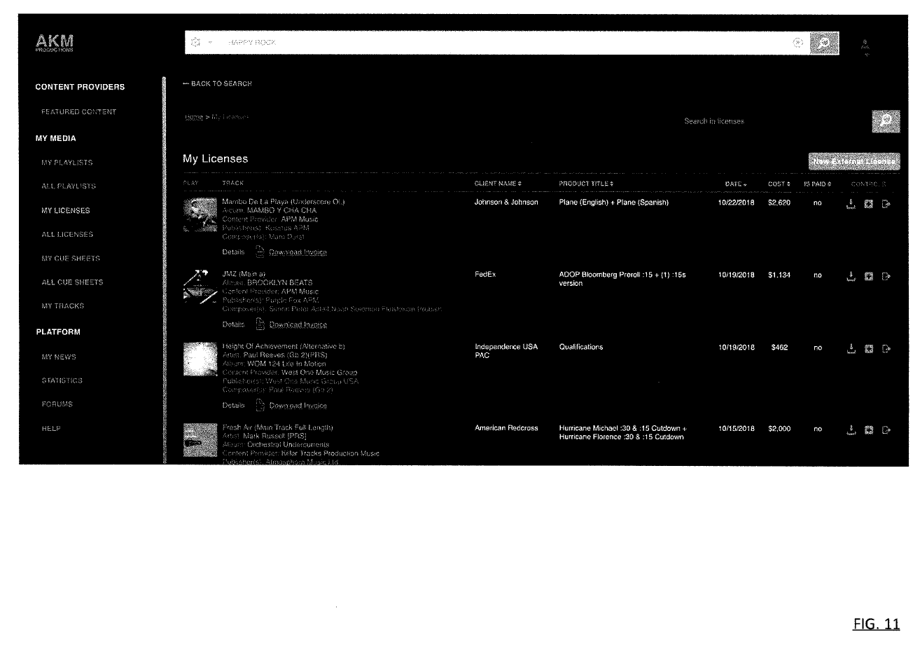

FIG. 11 illustrates an example of a “My License” screen display which shows the various licenses generated by the user 110. In certain embodiments, the user 110 may not be permitted to access the license approval documents until full payment is received. Once full payment is received, then the user 110 has the ability to download the license documents. This is important because it promotes compliance by users 110 with copyright laws and properly compensates copyright holders for use of their content. In certain embodiments, the system 101 may be programmed to notify the user 110 if payment has not been received. In other aspects, the system 101 may be programmed to communicate term reminders, such as when a license is about to expire, for example. These important license administration features can be used to help users 110 avoid potential copyright infringement issues.

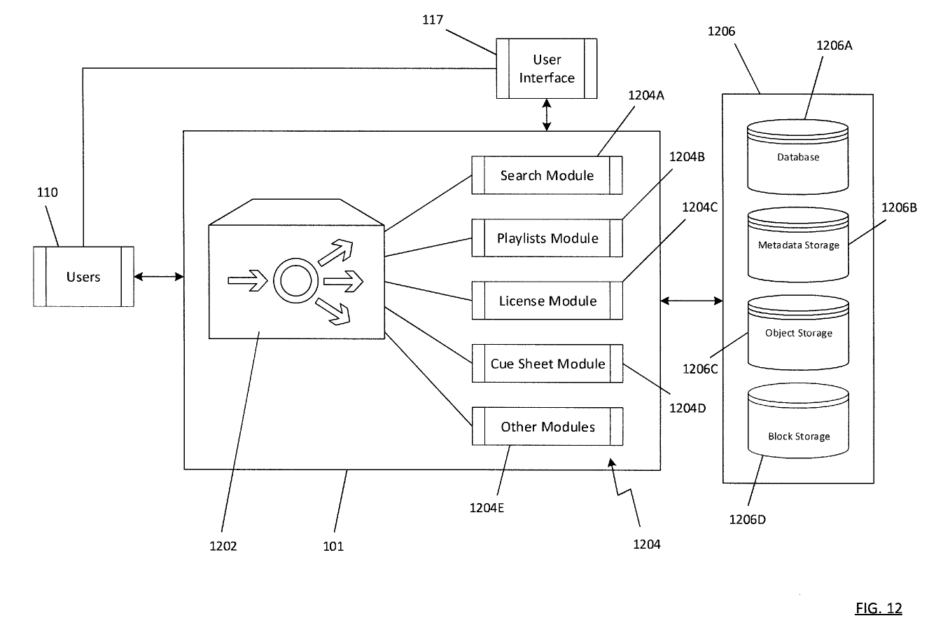

FIG. 12 includes a schematic depiction of an example of a computer architecture structured for processing requests for content and for retrieving content from data storage based on predetermined parameters. In this example, and in addition to other potential features and functions of computer systems described herein, the computer system 101 includes a load balancer 1202 programmed for receiving, processing, and returning the results of requests for content and other commands from different users 110. The load balancer 1202 serves to efficiently distribute incoming communications across a group of backend servers, a server farm, or a server pool, among other computing devices used by the system 101 to process user 110 requests. In various embodiments, the load balancer 1202 routes client requests across multiple backend servers capable of fulfilling those requests in a manner that maximizes speed and capacity utilization and ensures that no one server is overworked, which could degrade performance. If one server becomes inoperative or is taken offline for maintenance or an upgrade, for example, then the load balancer 1202 can redirect traffic to the remaining online and available servers. In this manner, the load balancer 1202 can perform one or more of the following functions: distributes client requests or network load efficiently across multiple servers; promotes enhanced availability and reliability by sending requests to servers that are active and available; and, provides the flexibility to install or remove servers or other computing devices subject to processing requirements of the computer system 101. Various factors which the load balancer 1202 can be programmed to consider when directing a user 110 request to a backend server of the system include bandwidth, highest or lowest processing load, frequency of use, and/or maintenance or upgrade status, for example, among other factors.

In this example, the system 101 can include a variety of different modules 1204 programmed to instantiate features and functions, including generating user interfaces 117, for users 110 of the system 101. Examples of modules 1204 include a search module 1204A, a playlists module 1204B, a license module 1204C, a cue sheet module 1204D, as well as a variety of other modules 1204E that can be programmed to perform other tasks within the system 101. It can be appreciated that each module 1204 can be configured to receive and respond to a particular kind of request communicated by different users 110.

In other aspects, the system 101 may be operatively associated with different types of content stored in different kinds of data storage media 1206. In general, content processed by the system 101 can be stored, selected, retrieved, and presented to users 110 in a manner that reflects that each type of the storage is chosen to store and retrieve different types of data as easily and quickly as possible. For example, it is usually easy to store information in a database storage medium about the identity of who licensed certain music. But storing actual audio files (e.g., MP3 files) in the database could be unnecessarily complicated to the extent that audio content previewed by a user 110 could take an undesirably long time to initiate playback due to the storage scheme used to store the audio content.

In one aspect of the data storage media 1206, a database 1206A can be programmed to store and retrieve transactional types of data such as created playlists, tracks licensed, licensee name, etc. In one embodiment, a defining characteristic of data stored in the database 1206A is that the data sets are substantially complete for each transaction of the same type. For example, when each playlist is created it will typically have a name, creation date, data for tracks in it, and so forth, similar to the attributes of other playlists stored in the database 1206A.

In another aspect of the data storage media 1206, metadata storage 1206B may be provided for use by the system 101 when storing or retrieving content from the data storage media 1206. These metadata may include descriptive metadata, structural metadata, administrative metadata, reference metadata, and/or statistical metadata, among other kinds of data which generally described attributes of the content stored in the data storage media 1206. In various embodiments, the metadata storage 1206B contains metadata for different tracks of music, for example, and other content. Each track can have a completely different set of data (unlike transactions in the database 1206A, for example). Some tracks may have just a title, album and artists (e.g., three data sets), but other tracks may have forty different data sets, for example. This data storage 1206B can be optimized to be readily searchable and to respond comparatively more quickly than other types of storage media 1206 or other data storage schema to return search results, for example. This reflects the fact that many users 110 access the system 101 to search music and other content by using keywords.

In another aspect of the data storage media 1206, object storage 1206C may be provided for storing data associated with a particular kind of content (e.g., audio, visual, or audiovisual content). The object storage 1206C may contain full audio files and images (e.g., album cover artwork). This content can be organized in sections of the object storage 1206C based on security policies and folders within those sections, for example, based on quality or format (e.g., for audio content) and/or resolution or visual quality (e.g., for images). In certain embodiments, object storage 1206C allows for use of relatively simple software code to generate a reference to a file or other content which is required for the system 101 to access the content for a particular purpose. In certain embodiments, content stored in object storage 1206C may be retained as a combination of data (e.g., an audio file), an amount of metadata (perhaps obtained from the metadata storage 1206B), and a unique identifier. The metadata may be defined by the creator of the object and may include contextual information about what the data is, how the data should be used, security classification, data quality characteristics, or other attributes that define how the data should be processed or accessed. The identifier may be a globally unique identifier, for example, and may be embodied as an address assigned to the object so the data can be readily located and retrieved within a distributed computing system, for example. In this manner, retrieving the data can be performed without necessarily knowing its actual physical or geographic location within the overall data storage system. In certain embodiments, a storage scheme for the object storage 1206C might involve not splitting data files into raw blocks of data. Rather, the data are grouped and stored in an object that contains the data, metadata, and the unique identifier.

In another aspect of the data storage media 1206, block storage 1206D may be provided. In certain embodiments, the block storage 1206D may be embodied as one or more hard drives that contain software code or other computer-executable instructions for executing applications, modules, or other computer-based functions of the system 101. The block storage 1206D may also be used to store static content (e.g., logos, icons, etc.) plus temporary files which are used by the system 101 and its modules. For example, when a user 110 uploads a file to the system 101, it can be uploaded from the computing device of that user 110 to the block storage 1206D and then later moved to other portions of the storage media 1206 if necessary or desirable. In another example, if a user 110 uploads a track of music to the block storage 1206, then the track may be subsequently moved to a location within the object storage 1206C. In addition, metadata can be created for that uploaded track, and the created metadata can be stored in the metadata storage 1206B. Also, a record reflecting that the user 110 completed an upload transaction for the music track can be stored in the database 1206A.

In one example, when a user 110 requests a high-quality audio file from the computer system 101 as content to be previewed, the audio file may be located and retrieved from object storage 1206C versus other parts of the data storage media 1206. In one embodiment, such high-quality audio may be stored as a 320 k MP3 file in the object storage 1206C, for example. In another aspect, if a comparatively lower quality audio file is acceptable to the user 110, then that audio content may be retrieved from a different location within the object storage 1206C, or from a data storage location other than the object storage 1206C. For example, the lower quality audio file in this scenario may be stored in another data storage location as a lower quality 128 k MP3 file instead of as a higher quality 320 k MP3 file.

It can be appreciated that embodiments of the present invention provide technical solutions in the computer system arts, particularly in the area of information technology employed by the licensing media industry. These technical solutions represent an unconventional approach and an advancement of data processing efficiency and effectiveness in a computing environment. By implementing various of the data structures and computer architecture described herein, for example, users can enhance the operating performance of computer systems while enhancing the user experience. It can be appreciated that embodiments of the present invention provide for significant automation benefits that enhance the speed and efficiency with which content can be retrieve in the licensing media environment. For example, a human could review piles of paper and stacks of files, sift through invoices, and send out reminders that an invoice is about to expire. A human user could also call hundreds of content suppliers to get a quote prior to searching for content and available licenses. However, embodiments of the present invention apply automated computer-based efficiencies to a process that normally would require hundreds of hours of manual effort to perform the same tasks.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

Whereas particular embodiments of this invention have been described above for purposes of illustration, it will be evident to those skilled in the art that numerous variations of the details of the present invention may be made without departing from the invention as defined in the appended claims.

What is claimed is:

1. A method, implemented by a computer system that includes at least one processor for automatically retrieving data associated with licensing media, the method comprising:
receiving a request including one or more inputs identifying at least one parameter for matching to one or more different media licenses or media license types;
employing a load balancer for determining at least one backend server of the computer system for processing the received request;
based on the at least one parameter, identifying one or more media licenses that correspond to the at least one parameter;
based on the request, locating content within a portion of multiple data storage media operatively associated with the computer system;
communicating the located content from the data storage media portion in response to a quality attribute associated with the content and with the request;
on a user interface screen display:
providing access to the communicated content by a user, and
displaying the one or more identified media licenses for selection by the user; and
upon selection by the user, adding the media license to a collection of media licenses that are to be purchased.

2. The method of claim 1, wherein the inputs identifying the at least one parameter comprise a project description, such that identification of the one or more media licenses that correspond to the at least one parameter comprises identifying media licenses that correspond to the project description.

3. The method of claim 1, further comprising displaying the media licenses in the collection of media licenses according to media license type, such that all media items with a specified license type are displayed in the user interface.

4. The method of claim 1, further comprising displaying each of the media licenses that are associated with a given media item, such that a single media item is displayed with a plurality of media licenses of different types.

5. The method of claim 1, further comprising displaying one or more portions of license usage information on the user interface screen display.

6. The method of claim 1, further comprising displaying a user interface element on the user interface screen display that, upon selection, displays license terms for a selected media license.

7. The method of claim 1, further comprising presenting information on the user interface screen display identifying the owner of the media.

8. The method of claim 1, further comprising presenting information on the user interface screen display that provides access to a collection of media playlists associated with the user.

9. The method of claim 1, further comprising presenting information on the user interface screen display that provides access to a collection of one or more licenses associated with the user.

10. The method of claim 1, further comprising presenting information on the user interface screen display identifying the owner of the media.

11. The method of claim 1, further comprising presenting information on the user interface screen display comprising a list of media items that are similar to the selected media item.

12. The method of claim 1, further comprising presenting at least one actionable element on the user interface screen display that allows the user to share one or more acquired licenses with another user.

13. The method of claim 1, further comprising presenting an actionable element on the user interface display screen that, upon selection, displays media item details associated with a selected media item.

14. The method of claim 1, further comprising presenting at least one actionable element on the user interface screen display associated with at least one of language dubbing, tags, commercial theme use, license terms, or a music use.

15. The method of claim 1, further comprising:
receiving at least one parameter from a budget filter tool; and
identifying media licenses that correspond to the parameter received from the budget filter tool.

16. The method of claim 1, further comprising receiving at least one parameter comprising license clearance information.

17. The method of claim 16, wherein the license clearance information comprises broadcast medium data, use type data, geographic scope data, or site type data.
